(19) United States
(12) Patent Application Publication
(10) Pub. No.: US 2026/0099235 A1
(43) Pub. Date: Apr. 9, 2026

(54) DISPLAY CONTROL METHOD AND SYSTEM

(71) Applicant: CASIO COMPUTER CO., LTD., Tokyo (JP)

(72) Inventors: Tomoki ISHIKAWA, Tokyo (JP); Kayoko ONODA, Tokyo (JP); Kanako NISHIZAWA, Tokyo (JP); Kunihiro MATSUBARA, Tokyo (JP)

(73) Assignee: CASIO COMPUTER CO., LTD., Tokyo (JP)

(21) Appl. No.: 19/352,745

(22) Filed: Oct. 8, 2025

(30) Foreign Application Priority Data
Oct. 9, 2024 (JP) 2024-177104

(51) Int. Cl. G06F 3/04815; G06F 3/0482; G06F 3/04847; G06F 3/0488

(52) U.S. Cl. CPC G06F 3/04815; G06F 3/0482; G06F 3/04847; G06F 3/0488; G06F 2203/04802

(57) ABSTRACT

A display control method performed by one or more processors, the method including: determining, based on state information pertaining to a state of a target, whether the target is in the state according to a priority order set for each of a plurality of states of the target with the states being a category different from each other; identifying a certain state as the state of the target in a case in which the target is determined to be in the certain state; selecting a state image corresponding to the identified state from a plurality of state images, wherein each of the state images represents the plurality of states and each of the state images includes an animated video; and displaying the selected state image on a display.

### CROSS-REFERENCE TO RELATED APPLICATIONS

This application claims priority and benefit of Japanese Patent Application No. 2024-177104 filed on October 9, 2024. The entire specification, claims, and drawings of Japanese Patent Application No. 2024-177104 are hereby incorporated by reference.

### BACKGROUND OF THE INVENTION

### TECHNICAL FIELD

The present disclosure relates to a display control method and a system.

### DESCRIPTION OF RELATED ART

Conventionally, a robot capable of mock communication with a user by performing various operations according to its state is known (e.g., Japanese Unexamined Patent Application Publication No. 2002-59389).

### SUMMARY OF INVENTION

A display control method according to the present disclosure is, the display control method performed by one or more processors, the method including:

determining, based on state information pertaining to a state of a target, whether the target is in the state according to a priority order set for each of a plurality of states of the target with the states being a category different from each other;

identifying a certain state as the state of the target in a case in which the target is determined to be in the certain state;

selecting a state image corresponding to the identified state from a plurality of state images, wherein each of the state images represents the plurality of states and each of the state images includes an animated video; and

displaying the selected state image on a display.

### BRIEF DESCRIPTION OF THE DRAWINGS

FIG. 1 shows an outer appearance of a robot and a smartphone.

FIG. 2 is a schematic diagram showing a configuration of a main body of a robot.

FIG. 3 is a block diagram showing a functional configuration of the robot.

FIG. 4 is a block diagram showing the functional configuration of the smartphone.

FIG. 5 is a diagram showing a home screen.

FIG. 6 is a diagram showing contents of state information.

FIG. 7 is a diagram showing an emotion map.

FIG. 8 is a diagram showing a priority order of a state of the robot and timing for displaying a state image.

FIG. 9 is a diagram showing the state images corresponding to "power off/communication off", "deep sleep mode" and "sleep mode".

FIG. 10 is a diagram showing the state images corresponding to external stimuli that the robot received.

FIG. 11 is a diagram shows the contents of previous display information.

FIG. 12 is a diagram showing the state images corresponding to emotions of the robot.

FIG. 13 is a diagram showing the state images corresponding to personalities of the robot.

FIG. 14 is a diagram showing a detailed information screen.

FIG. 15 is a diagram showing a setting screen.

FIG. 16 is a flowchart showing a control procedure for a home screen display process.

FIG. 17 is a flowchart showing the control procedure for the home screen display process.

### DETAILED DESCRIPTION

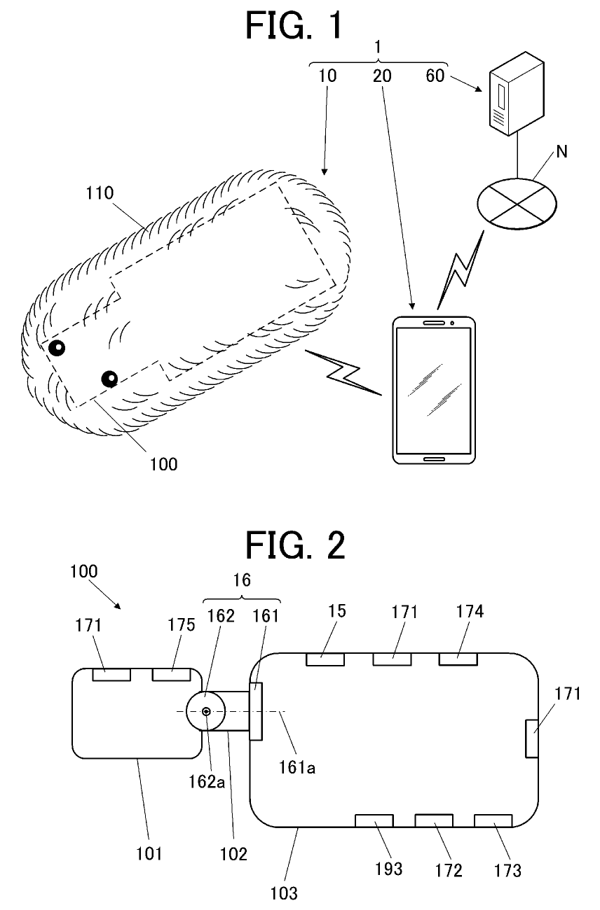

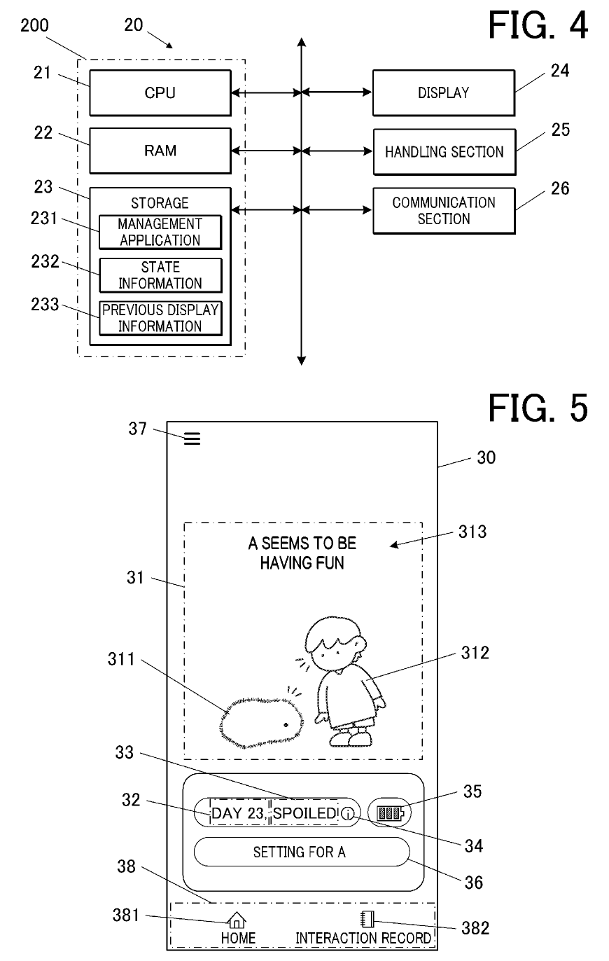

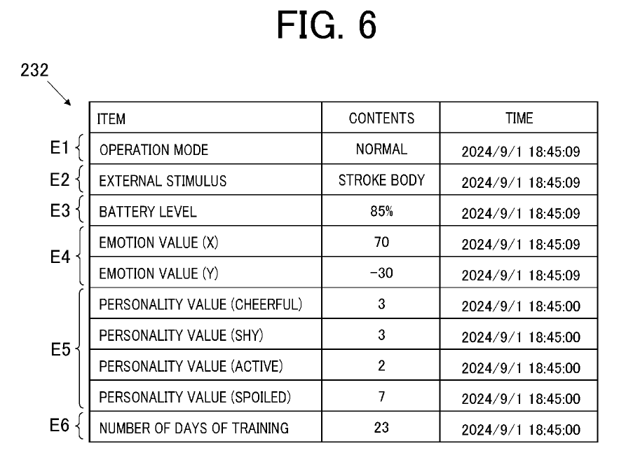

The following is a description of the embodiments of the present disclosure based on the drawings. As shown in FIG. 1, a robot management system 1 (system) includes a robot 10, a smartphone 20 (terminal device), and a server 60. The robot 10 includes a main body 100 and an exterior 110 that covers an entire surface of the main body 100. The robot 10 is a pet robot that mimics a small creature. The robot 10 can perform multiple operations that differ from each other to mimic gestures of the creature. The exterior 110 is made of a flexible material and deforms in response to a movement of the main body 100. The exterior 110 includes, for example, fur formed by pile fabric and decorative members that resemble eyes. The smartphone 20 is capable of communicating and connecting with the robot 10 via short-range wireless communication. According to the present embodiment, BLE (Bluetooth (registered trademark) Low Energy) is used for the short-range wireless communication. However, methods of the short-range wireless communication other than BLE may be used. The robot 10 and the smartphone 20 operate in coordination with each other by sending and receiving data through a communication connection using BLE. For example, the smartphone 20 acquires state information 232 (see FIG. 4 and FIG. 6) pertaining to a state of the robot 10 from the robot 10. Based on this state information 232, the smartphone 20 displays on the display 24 a home screen (see FIG. 5) containing various information pertaining to the state of the robot 10 on a management application 231 (program) used to manage the robot 10 as the target. It may be possible to link two or more robots 10 to one smartphone 20. Other types of devices such as tablet terminals, smartwatches, laptops or management servers may be used instead of the smartphone 20. The smartphone 20 is communicatively connected to the server 60 via a network N such as the Internet. The smartphone 20 forwards data acquired from the robot 10 (e.g., not shown logs containing information pertaining to history of the robot 10) to the server 60. The data stored on the server 60 is referred to, for example, as a backup.

As shown in FIG. 2, the main body 100 of the robot 10 includes a head 101, a body 103, and a coupling 102 that connects the head 101 and the body 103. The main body 100 includes a driver 16 that moves the head 101 with respect to the body 103. The driver 16 includes a twist motor 161 and a vertical movement motor 162. The twist motor 161 is a servo motor that rotates the head 101 and the coupling 102 around a first rotation axis 161a within a predetermined angular range. The first rotation axis 161a extends in an extending direction of the coupling 102. The operation of the twist motor 161 enables the robot 10 to twist the head 101. The vertical movement motor 162 is a servo motor that rotates the head 101 around a second rotation axis 162a within a predetermined angular range. The second rotation axis 162a is perpendicular to the first rotation axis 161a. The vertical movement motor 162 enables the robot 10 to move the head 101 up and down. A direction of a vertical movement of the head 101 can also be inclined with respect to a vertical direction, depending on an angle of a twist of the head 101 by the twist motor 161. By operating the twist motor 161 and/or the vertical movement motor 162 in a finely periodic manner, the robot 10 can achieve a shaking or trembling motion of the head 101. By changing timing, magnitude, and speed of the operation of the twist motor 161 and the vertical movement motor 162, and combining them as appropriate, the robot 10 can be made to perform a variety of operations, for example, a joyful operation, a surprised operation, a breathing operation that mimics the breathing of the creature, and the like. Among these, the breathing operation is a form of spontaneous operation by the robot 10.

As shown in FIG. 2, the main body 100 includes a touch sensor 171, an acceleration sensor 172, a gyro sensor 173, an illuminance sensor 174, a microphone 175, a sound output section 15, and a power reception coil 193. The touch sensors 171 are provided on the top of the head 101 and the top and the side of the body 103. The acceleration sensor 172, the gyro sensor 173, and the power reception coil 193 are provided near a lower surface of the body 103. The illuminance sensor 174 and the sound output section 15 are provided at the top of the body 103. The microphone 175 is provided at the top of the head 101 near a base of the head 101.

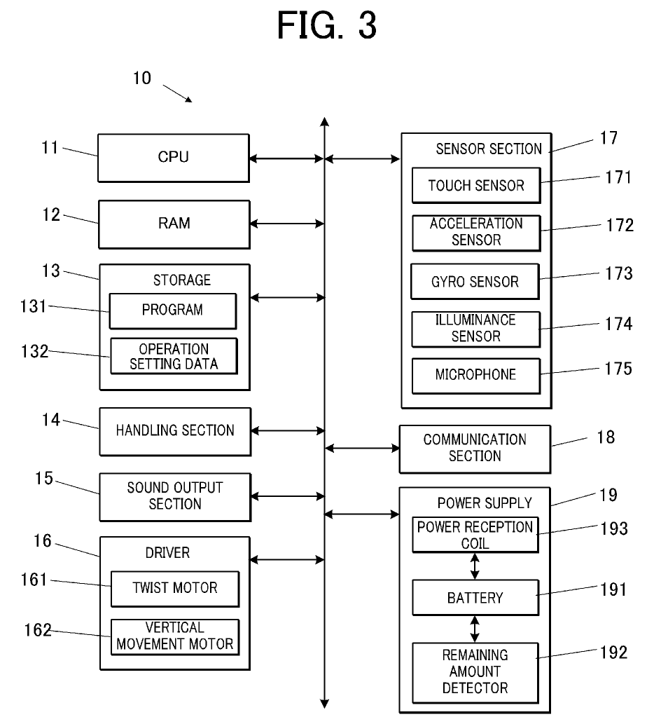

As shown in FIG. 3, the robot 10 includes a CPU 11 (Central Processing Unit), a RAM 12 (Random Access Memory), a storage 13, a handling section 14, a sound output section 15, a driver 16, a sensor section 17, a communication section 18, and a power supply 19. Each part of the robot 10 is connected via a data transmission path such as a bus, etc. Each of the functional configurations shown in FIG. 3 is provided in the main body 100.

The CPU 11 is a processor that reads and executes a program 131 stored in the storage 13 and performs various arithmetic processes to control the operation of the robot 10. The robot 10 may include a plurality of processors (e.g., plurality of CPUs), and the plurality of processes executed by the CPU 11 according to the present embodiment may be executed by such plurality of processors. In this case, the plurality of processors may be involved in a common process, or the plurality of processors may independently execute different processes in parallel. The RAM 12 provides a working memory space for the CPU 11 and stores temporary data. The storage 13 is a non-transitory recording medium readable by the CPU 11 as a computer and stores the program 131 and various data. Thus, the storage 13 encompasses a computer program product that includes the program 131. The storage 13 includes a nonvolatile memory, such as a flash memory, for example. The program 131 is stored in the storage 13 in a form of a computer-readable program code. The program 131 contains firmware to control each hardware of the robot 10. The data stored in the storage 13 includes operation setting data 132. The contents of the operation are set in the operation setting data 132. Examples of the operations include, communication operations performed by the robot 10 according to the state of the robot 10 or the contents of external stimuli, automatically generated operations that the robot 10 performs spontaneously without external stimuli, breathing operation, and the like. The automatically generated operations can be described as whimsical operations, as the robot 10 appears to gesture whimsically. Settings pertaining to the content of the operation include, for example, settings for the timing and amount of the operation of the twist motor 161 and the vertical movement motor 162 of the driver 16, as well as settings for a pitch, length, and volume of a sound output by the sound output section 15.

The handling section 14 includes handling buttons, a handling knob, etc. for turning the power on and off, adjusting the volume of the sound output by the sound output section 15, and so on. The handling section 14 outputs handling information to the CPU 11 in response to handling which is input to the handling buttons and the handling knob. The sound output section 15 includes a speaker and outputs the sound at the pitch, length, and volume according to a control signal and sound data transmitted from the CPU 11. Such sound may be the sound that imitates a cry of the creature. The driver 16 operates the twist motor 161 and the vertical movement motor 162 described above according to the control signal transmitted from the CPU 11.

The sensor section 17 includes the touch sensor 171, the acceleration sensor 172, the gyro sensor 173, the illuminance sensor 174, and the microphone 175 described above, and outputs the sensing results from each sensor and the microphone 175 to the CPU 11. The touch sensor 171 senses when the user or other object contacts the robot 10. The touch sensor 171 includes a pressure sensor or a capacitance sensor, for example, and outputs to the CPU 11 sensing data regarding whether there is contact to the robot 10. The acceleration sensor 172 senses acceleration for each of three orthogonal axis directions and outputs the sensing data to the CPU 11. The gyro sensor 173 senses angular velocity around each of the three orthogonal axis directions and outputs the sensing data to the CPU 11. The illuminance sensor 174 senses ambient brightness around the robot 10 and outputs the sensing data to the CPU 11. The microphone 175 senses the sound around the robot 10 and outputs the sensed sound data to the CPU 11.

The communication section 18 is a communication module including an antenna, modulation and demodulation circuit, signal processing circuit, etc., and performs wireless data communication with the smartphone 20 according to a BLE communication standard. The power supply 19 includes a battery 191, a remaining amount detector 192, and the power reception coil 193. The battery 191 supplies power to various parts of the robot 10. The battery 191 according to the present embodiment is a rechargeable battery that can be repeatedly recharged using a non-contact recharging method. The remaining amount detector 192 detects a remaining battery level of the battery 191 according to the control signal sent from the CPU 11 and outputs the detection results to the CPU 11. The charging operation of the battery 191 is performed with the robot 10 stored (installed) inside a dedicated power feeder (storage unit, charging dock), which is not shown in the drawings. The power feeder includes a power transmission coil for charging the battery 191 by electromagnetic induction at a position opposite the power reception coil 193 when the robot 10 is stored.

As shown in FIG. 4, the smartphone 20 includes a CPU 21 (processor, processing means), a RAM 22, a storage 23, a display 24, a handling section 25, and a communication section 26. Each part of the smartphone 20 is connected via the data transmission path such as the bus, etc. The CPU 21, the RAM 22, and the storage 23 constitute a display control apparatus 200 that controls a display operation of the display 24.

The CPU 21 is a processor that controls the operation of the smartphone 20 by reading and executing programs such as the management application 231 stored in the storage 23 and performing various arithmetic processing. The CPU 21 is an example of one or more processors. The smartphone 20 may include the plurality of processors (e.g., plurality of CPUs), and the plurality of processes executed by the CPU 21 according to the present embodiment may be executed by such plurality of processors. In this case, the plurality of processors are included in the one or more processors. In this case, the plurality of processors may be involved in a common process, or the plurality of processors may independently execute different processes in parallel. The RAM 22 provides a working memory space for the CPU 21 and stores temporary data. The storage 23 is a non-transitory recording medium readable by the CPU 21 as the computer and stores the program such as the management application 231 and various data. Thus, the storage 23 encompasses the computer program product that includes the program. Management of the robot 10 by the management application 231 means displaying at least information pertaining to the state of the robot 10 on a predetermined display. The storage 23 includes a nonvolatile memory, such as a flash memory, for example. The data stored in the storage 23 includes state information 232 and previous display information 233. The contents of the state information 232 and the previous display information 233 are described below.

The display 24 includes a display panel, such as a liquid crystal panel, capable of displaying in a dot matrix format, and a driving circuit for such display panel. The display 24 displays various menus, screens of the management application 231, etc. according to the control signal sent from the CPU 21. The handling section 25 includes a handling means such as a touch screen and handling buttons that are provided overlapped on a display panel of the display 24, and outputs handling signals corresponding to handling on the handling means to the CPU 21. The communication section 26 is a communication module including the antenna, the modulation and demodulation circuit, the signal processing circuit, etc., and performs wireless data communication with the robot 10 according to the BLE communication standard. The communication section 26 transmits and receives voice data for telephone communication and packet data for Internet connection to and from a base station.

The operation of the robot management system 1 is described next. When the user performs the handling on the handling section 25 of the smartphone 20 in order to instruct the start of the management application 231, the CPU 21 executes and starts the management application 231. The display operation of the display 24 described below is executed by the CPU 21 executing a predetermined process in accordance with the management application 231 and controlling the display 24. The management application 231 corresponds to a predetermined application program for displaying the state image 31 on the display 24. When the CPU 21 starts the management application 231, the CPU 21 acquires the state information 232 from the robot 10 and displays a home screen 30 shown in FIG. 5 on the display 24 based on the state information 232. Before displaying the home screen 30, a predetermined splash screen or welcome screen may be displayed. The home screen 30 displays a state image 31, a growth days image (image showing number of days of growth) 32, a personality image 33, an information mark 34, a remaining battery level image 35, a setting button 36, a menu mark 37, and a tab bar 38 in a predetermined arrangement. Details of these images, marks, etc. are described below. A letter "A" in FIG. 5 is a name given to the robot 10 by the user on the management application 231. The state image 31, the growth days image 32, the personality image 33, and the remaining battery level image 35 represent the state of the robot 10. Among the above, the growth days image 32 and the personality image 33 are each one type of "information that is updated according to the history of the robot". Thus, the home screen 30 contains various information pertaining to the state of the robot 10. By viewing the home screen 30, the user can learn about the real-time state of the robot 10.

Referring to FIG. 6, the contents of the state information 232 that the CPU 21 refers to when displaying the home screen 30 and elements E1 to E6 representing the state of the robot 10 are explained. The state information 232 includes data pertaining to each of the elements E1 to E6, which represent the state of the robot 10. In detail, the state information 232 includes data representing the contents of each of the elements E1 to E6 and information on the time when each data was generated in the robot 10 (or the time when the data was received by the smartphone 20). The element E1 is an "operation mode" of the robot. The operation modes of the robot 10 according to the present embodiment include "normal mode," "deep sleep mode," and "sleep mode". The "normal mode" is a mode in which the robot 10 performs communicative operations in response to external stimuli or performs automatically generated operations when predetermined conditions are met. The "deep sleep mode" is a mode in which the head 101 of the robot 10 stops moving and the sound output from the sound output section 15 stops. The "deep sleep mode" is executed when a toggle switch 52 is switched to ON in a setting screen 50 (see FIG. 15) described below. The "sleep mode" is a mode in which the response by the robot 10 in response to external stimuli is suppressed to express that the creature is sleeping. The "sleep mode" is executed, for example, when external stimuli (ambient illumination, etc.) meet predetermined conditions. The "deep sleep mode" and the "sleep mode" are a form of "function suppression mode" in which the functions of the robot 10 are suppressed. Therefore, the element E1 represents "whether or not the robot 10 is operating in the predetermined function suppression mode". The types of "operation mode" described above are examples and are not limited to these.

The element E2 is "external stimulus" and represents the type of stimulus that the robot 10 receives from the outside. The types of external stimuli include, and are not limited to, "loud noise," "talking," "body stroking," "head stroking," "lifting," "upside down," "swinging," etc., for example. The external stimuli related to sound, such as "loud noise" or "talking," are detected based on the sensing data from the microphone 175. The external stimuli related to contact, such as "body stroking" or "head stroking," are detected based on the sensing data from the touch sensor 171. The external stimuli involving posture changes such as "lifting," "upside down," and "swinging" are detected based on the sensing data from the acceleration sensor 172 and the gyro sensor 173. The element E3 is the "remaining battery level" of the battery 191. The "remaining battery level" is expressed as a percentage in which the fully charged battery is shown as 100%. The "remaining battery level" is detected by the remaining amount detector 192.

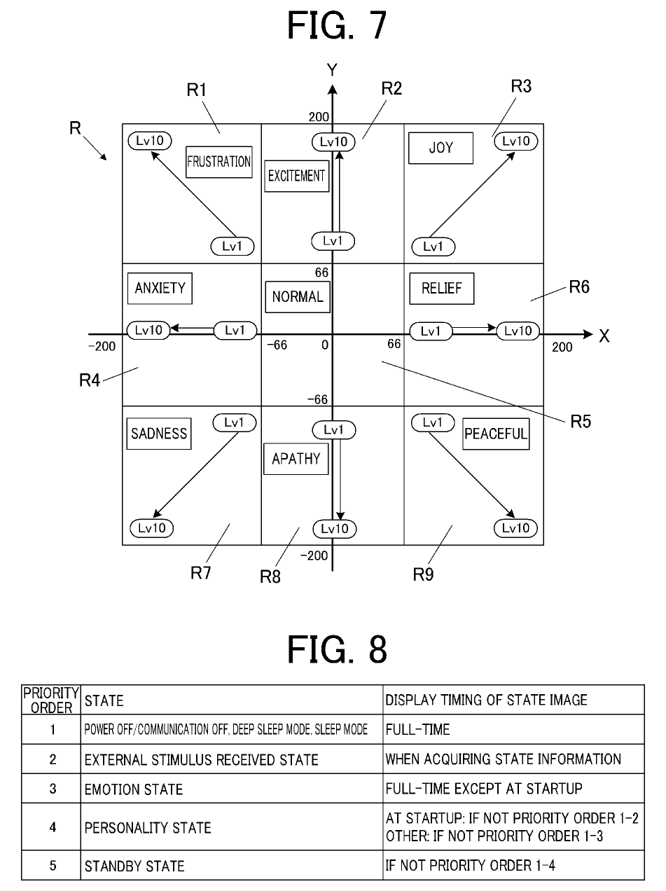

The element E4 is an emotional parameter that represents the pseudo-emotion of the robot 10. The element E4 consists of "emotion value (X)" and "emotion value (Y)" (hereinafter also collectively referred to as "emotion value"). The emotion value represents the pseudo-emotion of the robot 10 according to the position of a plot in an emotion map in an XY coordinate plane shown in FIG. 7. The "emotion value (X)" is the position in an X-axis direction of the plot, with larger values indicating higher levels of relief and smaller values indicating higher levels of anxiety. The "emotion value (Y)" is the position in a Y-axis direction of the plot, with larger values indicating higher levels of excitement and smaller values indicating higher levels of apathy. A maximum value of the "emotion value (X)" is "200" and a minimum value is "-200". The maximum value of the "emotion value (Y)" is "200" and the minimum value is "-200". Therefore, the emotion value is one of the coordinates within a square emotion region R, which has a length of 400 on one side. The emotion region R is divided into nine square regions R1 to R9 arranged in a 3x3 matrix. The regions R1 to R9 each represent a certain emotion of the robot 10. The region R1 satisfying -200 ≤ X ≤ -67 and 67 ≤ Y ≤ 200 represents the emotion of "frustration". The region R2 satisfying -66 ≤ X ≤ 66 and 67 ≤ Y ≤ 200 represents the emotion of "excitement". The region R3 satisfying 67 ≤ X ≤ 200 and 67 ≤ Y ≤ 200, represents the emotion of "joy". The region R4 satisfying -200 ≤ X ≤ -67 and -66 ≤ Y ≤ 66 represents the emotion of "anxiety". The region R5 satisfying -66 ≤ X ≤ 66 and -66 ≤ Y ≤ 66 represents the emotion of "normal". The region R6 satisfying 67 ≤ X ≤ 200 and -66 ≤ Y ≤ 66 represents the emotion of "relief". The region R7 satisfying -200 ≤ X ≤ -67 and -200 ≤ Y ≤ -67 represents the emotion of "sadness". The region R8 satisfying -66 ≤ X ≤ 66 and -200 ≤ Y ≤ -67 represents the emotion of "apathy". The region R9 satisfying 67 ≤ X ≤ 200 and -200 ≤ Y ≤ -67 represents the emotion of "peaceful". The regions R1 to R4 and R6 to R9, which correspond to the eight types of emotions except "normal," are further divided into ten level regions ("Lv1" to "Lv10"), each interior representing ten different levels. In each of the regions R1 to R4 and R6 to R9, the closer to the "normal" region R5, the level region with the lower level is located, and the farther from the "normal" region R5, the level region with the higher level is located. In the following, the emotion state of the robot 10 may be shown by combining the type of emotion and the level of the emotion such as "Relief Lv 10", etc. The length of one side of the emotion region R and the regions R1 to R9 may increase within a certain range as the robot 10 grows. For example, the emotion region R in an initial state may be a region -100 ≤ X ≤ 100 and -100 ≤ Y ≤ 100, and may increase to the region -200 ≤ X ≤ 200 and -200 ≤ Y ≤ 200 as the robot 10 grows. The emotion value changes from time to time in response to external stimuli received by the robot 10. The amount of change in one emotion value is selected from the following variables DXP, DXM, DYP, and DYM.

DXP: Amount of change in +X direction

DXM: Amount of change in -X direction

DYP: Amount of change in +Y direction

DYM: Amount of change in -Y direction

It can also be said that the variable DXP represents ease of feeling relief, the variable DXM represents ease of feeling anxious, the variable DYP represents ease of feeling excited, and the variable DYM represents ease of feeling apathetic. According to the present embodiment, an initial value of the variables DXP, DXM, DYP, and DYM is "10". The variables DXP, DXM, DYP, and DYM are increased by a predetermined amount when the emotion values reach their maximum values in the +X-axis direction, -X-axis direction, +Y-axis direction, and -Y-axis direction, respectively. According to the present embodiment, the maximum value of the variables DXP, DXM, DYP, and DYM is "20".

The element E5 shown in FIG. 6 is a personality parameter that represents the pseudo-personality of the robot 10. The element E5 consists of "personality value (cheerful)", "personality value (shy)", "personality value (active)" and "personality value (spoiled)" (hereinafter collectively referred to as "personality value"). The "personality value (cheerful)" is the value acquired by subtracting "10" from the variable DXP, and represents the likelihood of the change on the emotion map in the X-axis positive direction, i.e., the likelihood of becoming relieved. The "personality value (shy)" is the value acquired by subtracting "10" from the variable DXM, and represents the likelihood of the change on the emotion map in the X-axis negative direction, i.e., the likelihood of becoming anxious. The "personality value (active)" is the value acquired by subtracting "10" from the variable DYP and represents the likelihood of the change on the emotion map in the Y-axis positive direction, i.e., the likelihood of becoming excited. The "personality value (spoiled)" is the value acquired by subtracting "10" from the variable DYM and represents the likelihood of the change on the emotion map in the Y-axis negative direction, i.e., the likelihood of becoming apathetic. Therefore, each personality value changes according to the change in the variables DXP, DXM, DYP, and DYM, with the initial value being "0" and the maximum value being "10". The personality corresponding to the largest personality value among the four personality values is considered to be the personality of the robot 10 at that point in time. For example, in the example shown in FIG. 6, the "personality value (spoiled)" is the largest at "7", so the personality of the robot 10 at this point is set to "spoiled". If two or more personality values are identical and maximum, one personality is decided according to a predetermined priority order. According to the present embodiment, the priority order of the personality is, from highest to lowest, "cheerful," "active," "shy," and "spoiled".

The element E6 is the "number of days of training" and represents the number of days (cumulative operation period) calculated from the date the robot 10 was first started. The "number of days of training" is counted up to five digits inside the robot 10. Among the elements E1 to E6, the elements E1, E2, and E4 to E6 are a form of information that is updated according to the history of the robot 10.

Each of the data for elements E1 to E6 is sequentially generated by the CPU 11 of the robot 10 according to the operating status of the robot 10 and stored in the storage 13 of the robot 10 along with the time that the data is generated. In a case in which the connection for communication is in progress with the robot 10 via BLE, the CPU 21 of the smartphone 20 repeatedly acquires the elements E1 to E6 of the state information 232 from the robot 10 at a predetermined frequency and updates the state information 232. In detail, the CPU 21 acquires and updates the data for elements E1 to E4 in the state information 232 from the robot 10 at a frequency of once per second. In addition, the CPU 21 acquires and updates the data for the elements E5 and E6 in the state information 232 from the robot 10 at a frequency of once per minute. Updating the state information 232 in this manner is equivalent to acquiring the state information 232. The format of the state information 232 is not limited to that shown in FIG. 6. For example, the state information 232 may be in the form of a queue that accumulates the elements E acquired from the robot 10 in chronological order.

The CPU 21 of the smartphone 20 displays the home screen 30 in FIG. 5 on the display 24 or updates the home screen 30 based on the latest state information 232. As shown in FIG. 5, the state image 31 is displayed in substantially the center of the home screen 30. The state image 31 includes an animated video that simply represents the state of the robot 10. In detail, the state image 31 includes an outer appearance image 311 that represents a certain element of the state of the robot 10 by the outer appearance of the robot 10. The outer appearance image 311 reflects the actual outer appearance of the robot 10, e.g., the color of the exterior 110. The state image 31 also includes an avatar image 312 representing the outer appearance of an avatar representing the user. The outer appearance image 311 and the avatar image 312 are the animated videos having a predetermined length. The animated video of the outer appearance image 311 and the avatar image 312 may be displayed repeatedly until the state image 31 is switched to another, or the animated video may be displayed repeatedly a predetermined number of times. The state image 31 also includes a text 313 representing a certain element of the state of the robot 10. The text 313 is displayed above the outer appearance image 311 and the avatar image 312, for example. Certain elements of the state of the robot 10 represented by the state image 31 include any of the following, whether or not the power of the robot 10 is turned on, whether or not the connection for communication is in progress between the robot 10 and the smartphone 20, whether or not the robot 10 is operating in the function suppression mode (deep sleep mode or sleep mode), whether or not the robot 10 received a predetermined external stimulus, the pseudo-emotion of the robot 10, and the pseudo-personality of the robot 10. The area of the display region of the state image 31 is larger than the area of the display region of each of the other images representing the state of the robot 10, and the other images are the growth days image 32, the personality image 33, and the remaining battery level image 35 (the area of the display region of the information corresponding to the elements different from the state image 31). The area of the display region of the state image 31 shall be the area of the rectangle which is the smallest rectangle surrounding the outer appearance image 311, the avatar image 312 and the text 313, and in which each side is parallel to the outline of the home screen 30.

The CPU 21 identifies the state of the robot 10 based on the state information 232. Then, from among the plurality of state images 31 that represent the plurality of the states of the robot 10 that are different from each other in category (type or kind), the CPU 21 selects the state image 31 corresponding to the identified state to be displayed on the display 24. The plurality of state images 31 are generated in advance and stored in the storage 23 of the smartphone 20. In detail, the CPU 21 determines whether or not the robot 10 is in the state according to the priority order set for each of the plurality of states, starting from the state with the highest priority order among the plurality of states. In a case in which the CPU 21 first determines that the robot 10 is in a certain state, the CPU 21 identifies the certain state as the state of the robot 10 and displays the state image 31 corresponding to the state on the display 24. According to the present embodiment, the priority order of the state of the robot 10 is predetermined for each category, as shown in FIG. 8. The priority order "1" includes the categories, "power off/communication off", "deep sleep mode", and "sleep mode". Among the above, "power off" is a state in which the power of the robot 10 is turned off, and "communication off" is a state in which there is no connection to perform communication between the robot 10 and the smartphone 20. The priority order "2" includes the category "external stimulus received state". The priority order "3" includes the category "emotion state" of the robot 10. The priority order "4" includes the category "personality state" of the robot 10. The priority order "5" includes the category "standby state", which is not any of the above states. In a case in which the robot 10 is in the state in the priority order "1", the state image 31 corresponding to that state is always displayed. The state image 31 corresponding to the state in the priority order "2" is displayed in a case in which the robot 10 is not in the state in the priority order "1" and when the element E2 of the state information 232 is acquired (updated). The state image 31 corresponding to the state in the priority order "3" is always displayed except when the management application is started, in a case in which the robot 10 is not in any of the states in the priority order "1" or "2". The state image 31 corresponding to the state in the priority order "4" is displayed in a case in which the robot 10 is not in any of the states in the priority order "1" or "2" when the management application is started, and is displayed in a case in which the robot 10 is not in any of the states in the priority orders "1" to "3" at times other than startup. According to the present embodiment, the case in which the robot 10 is not in the state in the priority order "3" shall be the case in which the coordinates of the emotion value in the element E4 of the state information 232 are not inside any of the regions R1 to R4 or R6 to R9, that is, the case in which the coordinates are within the "normal" region R5. The state image 31 corresponding to the state in the priority order "5" is displayed in a case in which the robot 10 is not in any of the states in the priority orders "1" to "4".

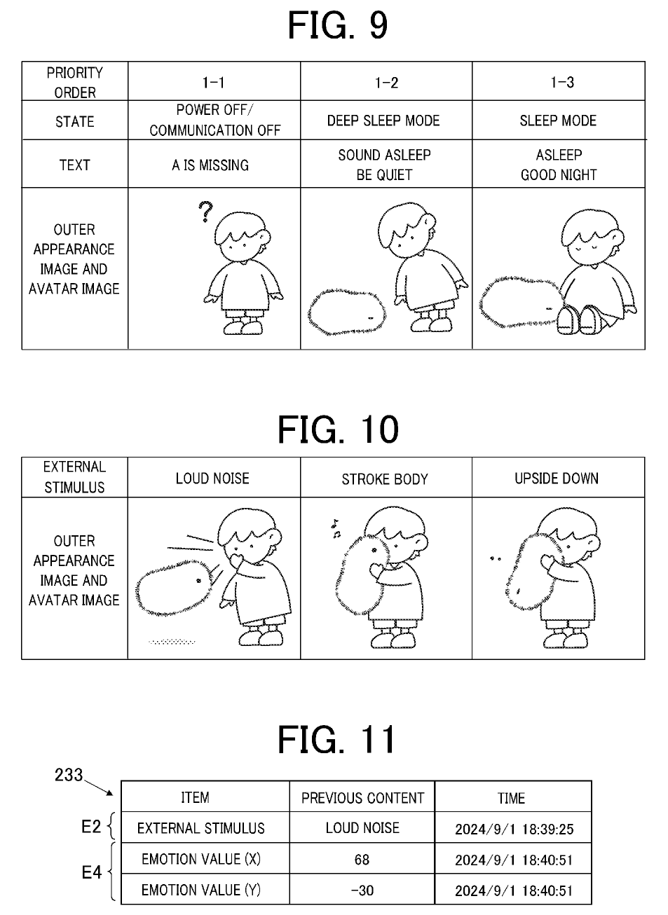

When displaying or updating the state image 31, the CPU 21 first makes a determination regarding the state in the priority order "1". Based on the state information 232, in a case in which the CPU 21 determines, that the robot 10 is in one of the "power off/communication off," "deep sleep mode," and "sleep mode," the CPU 21 selects from among the plurality of state images the state image 31 corresponding to the determined state among the "power off/communication off," "deep sleep mode," and "sleep mode," and displays the selected state image 31 on the display 24. The determination of "deep sleep mode" and "sleep mode" is based on the element E1 of the state information 232. As shown in FIG. 9, the three states with the priority order "1" are further prioritized among each other. The highest priority order "1-1" is assigned to "power off/communication off", the next highest priority order "1-2" is assigned to "deep sleep mode", and the next highest priority order "1-3" is assigned to "sleep mode". In a case in which the robot 10 is in the "power off/communication off" state, the CPU 21 displays the state image 31 which includes the avatar image 312 and the text 313 shown on the left side of FIG. 9. In other words, the state image 31 in this case does not include the outer appearance image 311, but includes the avatar image 312, which is an animated video of the avatar looking for the robot 10. This expresses that the robot 10 is in the "power off/communication off" state. The text 313 contains a statement indicating that the robot 10 is not found. In a case in which the robot 10 is not in the "power off/communication off" state and is in the "deep sleep mode", the CPU 21 displays the state image 31 which includes the outer appearance image 311 and the avatar image 312 shown in the center of FIG. 9 and the text 313. The outer appearance image 311 included in this state image 31 includes an animated video of the robot 10 in deep sleep, and the avatar image 312 includes an animated video of the avatar watching over the robot 10. The text 313 includes a statement indicating that the robot 10 is in the deep sleep. In a case in which the robot 10 is not in either the "power off/communication off" or the "deep sleep mode" and is in the "sleep mode," the CPU 21 displays the state image 31, which includes the outer appearance image 311 and the avatar image 312 shown on the right side of FIG. 9, and the text 313. The outer appearance image 311 included in this state image 31 includes the animated video of the sleeping robot 10, and the avatar image 312 includes the animated video of the avatar sleeping with the robot 10. The text 313 includes a statement indicating that the robot 10 is sleeping.

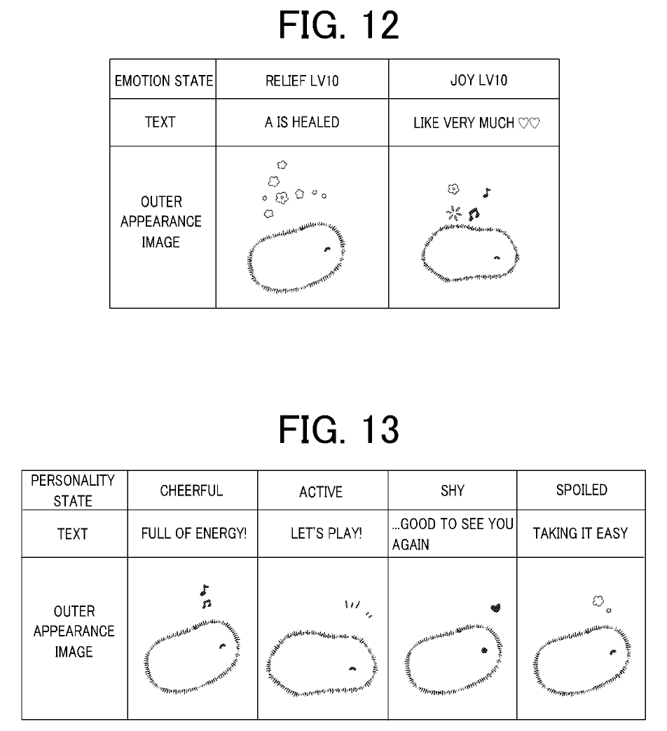

In a case in which the CPU 21 determines that the robot 10 is not in any of the states of the "power off/communication off", the "deep sleep mode" or the "sleep mode", the CPU 21 determines whether or not the robot 10 is in the "external stimulus received state" based on the element E2 in the state information 232. In a case in which the CPU 21 determines that the robot 10 is in the "external stimulus received state," the CPU 21 selects the state image 31 corresponding to the external stimulus received by the robot 10 from among the plurality of state images 31 and displays the selected state image 31 on the display 24. For example, in a case in which the external stimulus that the robot 10 receives is a "loud noise", the CPU 21 displays the state image 31 including the outer appearance image 311 and the avatar image 312 shown on the left side of FIG. 10. The outer appearance image 311 of the state image 31 includes the animated video of the surprised robot 10, and the avatar image 312 includes the animated video of the avatar outputting a loud voice. In a case in which the external stimulus that the robot 10 receives is "stroking the body", the CPU 21 displays the state image 31 including the outer appearance image 311 and the avatar image 312 shown in the center of FIG. 10. The outer appearance image 311 of this state image 31 includes the animated video of the robot 10 who is happy to have his body stroked, and the avatar image 312 includes the animated video of the avatar stroking the body of the robot 10. In a case in which the external stimulus that the robot 10 receives is "upside down", the CPU 21 displays the state image 31 including the outer appearance image 311 and the avatar image 312 shown on the right side of FIG. 10. The outer appearance image 311 of this state image 31 includes the animated video of the robot 10 upside down, and the avatar image 312 includes the animated video of the avatar holding the robot 10 upside down. Each state image 31 corresponding to the external stimulus does not contain the text 313. The state images 31 corresponding to the external stimuli are not limited to those shown in FIG. 10, but are provided for each external stimulus. In a case in which the state image 31 corresponding to the "external stimulus received state" is displayed, the CPU 21 records the element E2 of the state information 232 referenced in that display in the previous display information 233, as shown in FIG. 11. In a case in which the CPU 21 determines that the robot 10 is in the "external stimulus received state" the next time, the CPU 21 displays the state image 31 corresponding to the external stimulus this time, only in a case in which the element E2 in the state information 232 used for such determination and the previous element E2 recorded in the previous display information 233 are different.

In a case in which the CPU 21 determines that the robot 10 is not in the "external stimulus received state", the CPU 21 identifies the "emotion state" of the robot 10 based on the element E4 in the state information 232. The CPU 21 then selects the state image 31 corresponding to the identified "emotion state" from the plurality of state images 31 and displays the selected state image 31 on the display 24. For example, in a case in which the emotion value of the robot 10 belongs to a "Relief Lv 10" region, the CPU 21 displays the state image 31 including the outer appearance image 311 and the text 313 shown on the left side of FIG. 12. The outer appearance image 311 of the state image 31 includes the animated video of the robot 10 feeling relieved. The text 313 also includes the statement that the robot 10 is feeling relief. In a case in which the emotion value of the robot 10 belongs to a "Joy Lv 10" region, the CPU 21 displays the state image 31 including the outer appearance image 311 and the text 313 shown on the right side of FIG. 12. The outer appearance image 311 of this state image 31 includes the animated video of the robot 10 feeling happy. The text 313 also includes the statement that the robot 10 is happy. Although the avatar image 312 is omitted in FIG. 12, the state image 31 corresponding to "emotion state" may further include the avatar image 312. The state images 31 corresponding to the "emotion states" are not limited to those shown in FIG. 12, but are prepared for each combination of the emotion type and the level. Two or more texts 313 that differ from each other for each combination of one emotion type and level may be provided, and any of these texts 313 may be selected and displayed at random or according to a predetermined rule. In a case in which the state image 31 corresponding to the "emotion state" is displayed, the CPU 21 records the element E4 of the state information 232 referenced in that display in the previous display information 233, as shown in FIG. 11. In a case in which the CPU 21 displays the state image 31 corresponding to the "emotion state" of the robot 10 the next time, the CPU 21 displays the state image 31 corresponding to the emotion state this time, only in a case in which the element E4 in the state information 232 at that time is different from the previous element E4 recorded in the previous display information 233.

In a case in which the CPU 21 determines that the robot 10 is not in the "external stimulus received state" and the state image 31 is not displayed on the display 24 after the management application 231 is started, the CPU 21 identifies the "personality state" of the robot 10 based on the element E5 included in the state information 232. The CPU 21 selects the state image 31 corresponding to the identified "personality state" from among the plurality of state images 31 and displays the selected state image 31 on the display 24. In other words, in a case in which the state image 31 displayed first after starting the management application 231 is not "power off/communication off", "deep sleep mode", "sleep mode", or "external stimulus received state", the CPU 21 displays the state image 31 corresponding to the "personality state". For example, in a case in which the personality of the robot 10 is "cheerful," the CPU 21 displays the state image 31 including the outer appearance image 311 and the text 313 shown on the leftmost side of FIG. 13. The outer appearance image 311 of this state image 31 includes the animated video of the robot 10 in a cheerful state. The text 313 contains the statement indicating that the robot 10 is cheerful. In a case in which the personality of the robot 10 is "active", the CPU 21 displays the state image 31 including the outer appearance image 311 and the text 313 shown second from the left in FIG. 13. The outer appearance image 311 of this state image 31 includes the animated video of the robot 10 in an active state. The text 313 contains the statement indicating that the robot 10 is active. In a case in which the personality of the robot 10 is "shy", the CPU 21 displays the state image 31 including the outer appearance image 311 and the text 313 shown second from the right in FIG. 13. The outer appearance image 311 of this state image 31 includes the animated video of the robot 10 in a shy state. The text 313 contains the statement indicating that the robot 10 is shy. In a case in which the personality of the robot 10 is "spoiled", the CPU 21 displays the state image 31 including the outer appearance image 311 and the text 313 shown on the rightmost side of FIG. 13. The outer appearance image 311 of this state image 31 includes the animated video of the robot 10 in a spoiled state. The text 313 contains the statement indicating that the robot 10 is spoiled. Although the avatar image 312 is omitted in FIG. 13, the state image 31 corresponding to the "personality state" may further include the avatar image 312. Two or more texts 313 that differ from each other for each of the four personalities may be provided, and any of these texts 313 may be selected and displayed at random or according to the predetermined rule. Except when the management application 231 is started, the CPU 21 displays the state image 31 corresponding to the "personality state" in a case in which the state of the robot 10 is not the "power off/communication off", the "deep sleep mode", the "sleep mode", or the "external stimulus received state", and the emotion is "normal". The state image 31 indicating a "standby state" is not shown, but may, for example, be the image including the outer appearance image 311 and the avatar image 312 of the robot 10 that is not performing any particular operation.

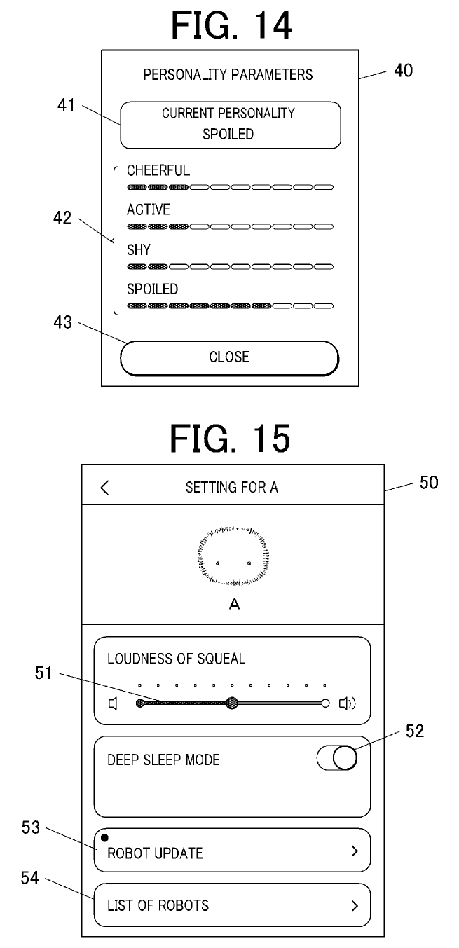

As shown in FIG. 5, the CPU 21 displays the growth days image 32, the personality image 33, the information mark 34 (first sign image), the remaining battery level image 35, and the setting button 36 (second sign image) in a predetermined arrangement at the bottom of the state image 31 on the home screen 30. At least one of the following may be displayed, the growth days image 32, the personality image 33, the information mark 34, the remaining battery level image 35, and the setting button 36. The numerical value of the number of days of growth included in the growth days image 32 is decided based on the element E6 of the state information 232. The personality image 33 displays the personality corresponding to the personality value that is the largest of the four personality values in the element E5 of the state information 232. The information mark 34 is a sign with a circle around a letter "i". In a case in which the handling to select the information mark 34 is performed, the CPU 21 displays a detailed information screen 40 shown in FIG. 14 on the display 24. The detailed information screen 40 includes detailed information pertaining to a certain element (in this case, personality) of the state of the robot 10. The detailed information screen 40 displays a personality 41 of the robot 10 at that point in time, a graph 42 showing the personality values of each of the four personalities at 11 levels from "0" to "10", and a button 43 to close the detailed information screen 40. The personality of the robot 10 may be updated once a day, for example, when the date changes. The remaining battery level image 35 shown in FIG. 5 is the image representing the remaining battery level of the battery 191 in three levels. In a case in which the battery 191 is being charged, a predetermined charging-in-progress mark may be further displayed in the remaining battery level image 35. A predetermined charging error mark may be further displayed in the remaining battery level image 35 in a case in which the battery 191 is not properly charged contactlessly while the robot 10 is stored in the power feeder. In a case in which the handling to select the setting button 36 is performed, the CPU 21 displays on the display 24 the setting screen 50 shown in FIG. 15 for setting the operation of the robot 10. The setting screen 50 displays a slider 51 for adjusting a volume of the sound (squeal) output from the sound output section 15 of the robot 10, a toggle switch 52 that is switched to on when the robot 10 is put into the deep sleep mode, an update button 53 for updating firmware of the robot 10, and a list button 54 for displaying a list of the robots 10 that are linked to the smartphone 20.

In the upper left corner of the home screen 30 shown in FIG. 5, a menu mark 37 is displayed. When the handling to select the menu mark 37 is performed, the CPU 21 displays a menu screen not shown in the drawings on the display 24. The menu screen can further display a screen for editing a profile of the user, a screen listing the robots 10 that are linked, a screen for newly registering (linking) the robot 10, and a screen displaying information such as the version of the management application 231. A tab bar 38 is displayed at the most bottom of the home screen 30. The tab bar 38 includes a home icon 381 and an interaction record icon 382. When the interaction record icon 382 is selected while the home screen 30 is displayed, the CPU 21 transitions the display on the display 24 from the home screen 30 to the interaction record screen not shown in the drawings. The interaction record screen displays information pertaining to the history of interaction between the robot 10 and the user. When the home icon 381 is selected while the interaction record screen is displayed, the CPU 21 transitions the display in the display 24 from the interaction record screen to the home screen 30.

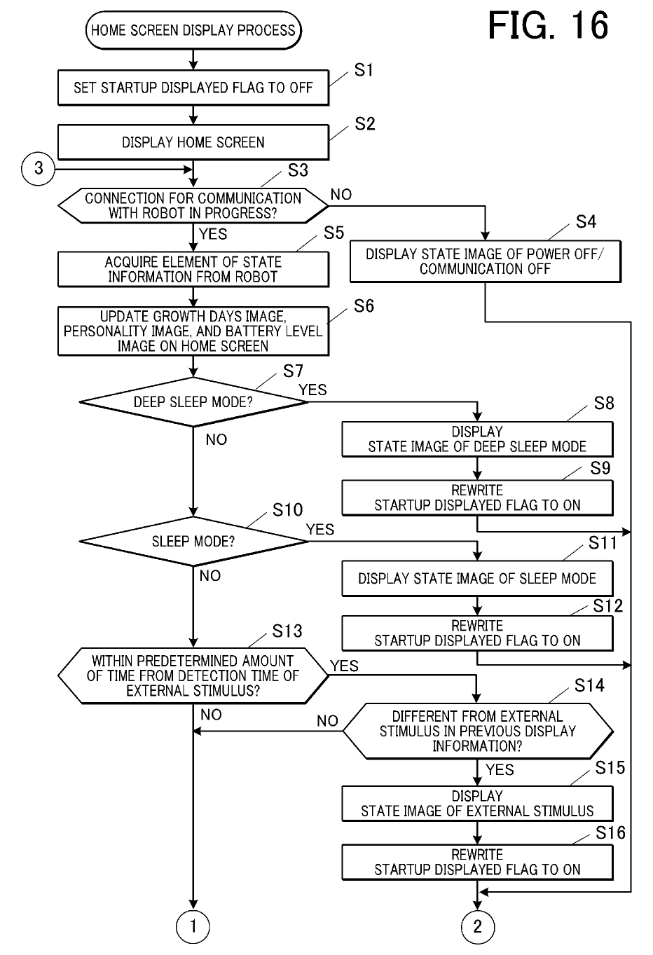

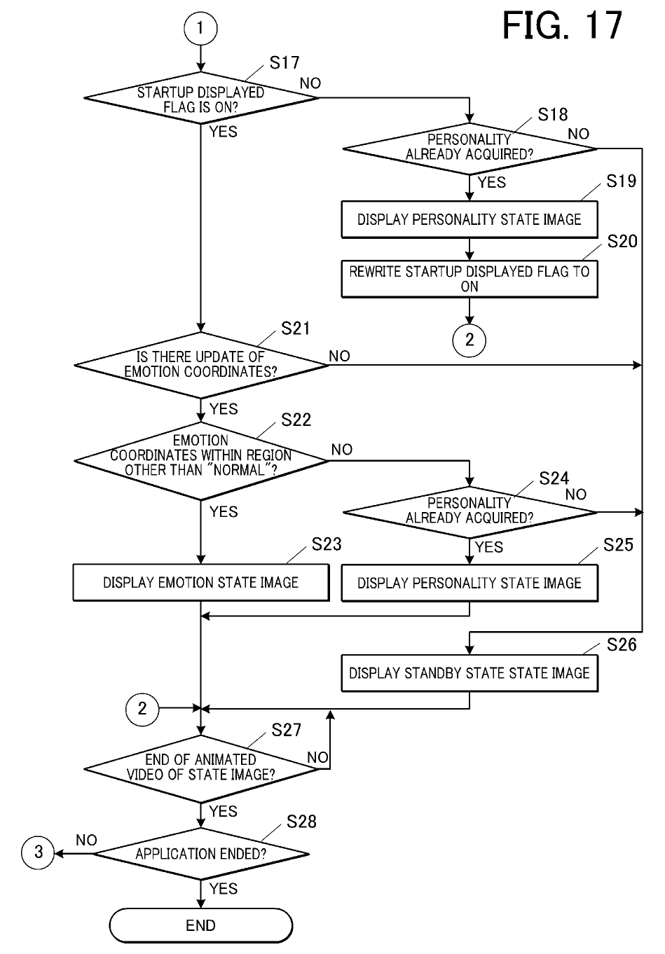

Referring now to FIG. 16 and FIG. 17, the home screen display process executed by the CPU 21 to achieve the above operation is described. The home screen display process is started in a case in which handling to start the management application 231 is performed on the handling section 25. When the home screen display process is started, the CPU 21 sets a startup displayed flag to "off" (step S1). The startup displayed flag is 1-bit data stored in the RAM 22, and "0" represents "off" and "1" represents "on". An "off" state for the startup displayed flag indicates that no state image 31 other than the "standby" state has been displayed yet after the management application 231 is started, while an "on" state for the startup displayed flag indicates that the state image 31 other than the "standby" state has already been displayed after the management application 231 is started. The CPU 21 displays the home screen 30 on the display 24 (step S2). At this stage, the state image 31, the growth days image 32, the personality image 33, and the remaining battery level image 35 may be in a state that the images are not displayed. The CPU 21 determines whether the connection for communication is in progress with the robot 10 via BLE (step S3). In a case in which it is determined that the connection for communication is not in progress ("NO" in step S3), the CPU 21 displays the state image 31 corresponding to "power off/communication off" on the home screen 30 (step S4). Here, the CPU 21 selects the state image 31 corresponding to "power off/communication off" from among the plurality of state images 31 stored in the storage 13, and acquires the image data of the state image 31 from the storage 13. The CPU 21 then sends the image data together with the control signal to the display 24, thereby displaying the selected state image 31 on the display 24. The process in the display of the other state images 31 described below is also identical, except for the type of state image 31 to be selected. In a case in which the power of the robot 10 is turned off, the connection for communication with the smartphone 20 is not established, and therefore, step S3 will branch to "NO". When step S4 is completed, the CPU 21 advances the process to step S27.

In a case in which it is determined that the connection for communication is in progress with the robot 10 ("YES" in step S3), the CPU 21 acquires the predetermined element of the state information 232 from the robot 10 (step S5). Here, the CPU 21 acquires the elements E1 to E4 from the robot 10 in a case in which the timing is once a second to acquire the elements E1 to E4. The CPU 21 acquires the elements E5 and E6 (and the elements E1 to E4) from the robot 10 in a case in which the timing is once a minute to acquire the elements E5 and E6. The CPU 21 updates (displays in a case it is not already displayed) the growth days image 32, the personality image 33, and the remaining battery level image 35 on the home screen 30 based on the latest state information 232 (step S6).

The CPU 21 determines whether or not the robot 10 is in the deep sleep mode based on the element E1 in the state information 232 (step S7). In a case in which it is determined that the robot 10 is in the deep sleep mode ("YES" in step S7), the CPU 21 displays on the display 24 the state image 31 corresponding to the deep sleep mode (step S8). The CPU 21 then rewrites the startup displayed flag to "on" (step S9) and advances the process to step S27. In a case in which the startup displayed flag has already been rewritten to "on," the CPU 21 omits step S9 (the same applies to subsequent steps S12, S16, and S20). In a case in which it is determined that the robot 10 is not in the deep sleep mode ("NO" in step S7), the CPU 21 determines whether the robot 10 is in the sleep mode based on the element E1 in the state information 232 (step S10). In a case in which it is determined that the robot 10 is in the sleep mode ("YES" in step S10), the CPU 21 displays on the display 24 the state image 31 corresponding to the sleep mode (step S11). The CPU 21 then rewrites the startup displayed flag to "on" (step S12) and advances the process to step S27.

In a case in which it is determined that the robot 10 is not in the sleep mode ("NO" in step S10), the CPU 21 determines, based on the element E2 of the state information 232 and the time information, whether or not it is within a predetermined amount of time from a detection time (a time of day of the detection) of the external stimulus that the robot 10 received (step S13). The predetermined amount of time may be 30 seconds, for example. In a case in which it is determined that it is within the predetermined amount of time from the detection time of the external stimulus ("YES" in step S13), the CPU 21 refers to the previous display information 233 to determine whether the current external stimulus is different from the external stimulus recorded in the state information 232 (step S14). Here, in a case in which at least one of the content and the time of the external stimulus of the element E2 in the latest state information 232 is different from the external stimulus recorded in the previous display information 233, or in a case in which the element E2 has not yet been recorded in the previous display information 233, the CPU 21 determines that the current external stimulus is different from the external stimulus recorded in the previous display information 233. In a case in which it is determined that the current external stimulus is different from the external stimulus recorded in the previous display information 233 ("YES" in step S14), the CPU 21 displays on the display 24 the state image 31 corresponding to the detected external stimulus (step S15). The CPU 21 then rewrites the startup displayed flag to "on" (step S16) and advances the process to step S27.

In a case in which it is determined that it is not within the predetermined amount of time from the detection time of the external stimulus (including the case where no external stimulus is detected) ("NO" in step S13), or in a case in which it is determined that the current external stimulus is the same as the external stimulus recorded in the previous display information 233 ("NO" in step S14), the CPU 21 determines whether or not the startup displayed flag is "on" (step S17 in FIG. 17). In a case in which it is determined that the startup displayed flag is "off", i.e., none of the state images 31 of "power off/communication off", "deep sleep mode", "sleep mode", or "external stimulus received state" is displayed after the management application 231 is started ("NO" in step S17), the CPU 21 determines whether or not the personality of the robot 10 has already been acquired (step S18). Here, the CPU 21 determines that the personality of the robot 10 has already been acquired in a case in which any of the personality values among the personality values of the element E5 in the state information 232 is "1" or more. Alternatively, the CPU 21 determines that the personality of the robot 10 has not been acquired in a case in which all the personality values are "0". In a case in which it is determined that the personality of the robot 10 has been acquired ("YES" in step S18), the CPU 21 displays on the display 24 the state image 31 corresponding to the personality of the robot 10 (step S19). The CPU 21 then rewrites the startup displayed flag to "on" (step S20) and advances the process to step S27.

In a case in which it is determined in step S17 that the startup displayed flag is "on" ("YES" in step S17), the CPU 21 determines whether or not there has been an update of the emotion coordinates based on the element E4 in the state information 232 (step S21). Here, the CPU 21 determines that there has been the update of the emotion coordinates in a case in which the difference between the time of the element E4 in the state information 232 and the current time is within a predetermined amount of time (e.g., within 12 seconds) and the coordinates of the element E4 in the state information 232 are different from the coordinates of the element E4 recorded in the previous display information 233. In a case in which it is determined that there has been the update of the emotion coordinates ("YES" in step S21), the CPU 21 determines whether or not the emotion coordinates in the element E4 of the state information 232 are inside the region other than "normal," that is, inside any of the regions R1 to R4, or R6 to R9 (step S22). In a case in which it is determined that the emotion coordinates are within the region other than "normal" ("YES" in step S22), the CPU 21 displays on the display the state image 31 of the emotion corresponding to the region to which the coordinate value of the element E4 of the state information 232 belongs (step S23). On the other hand, in a case in which it is determined that the emotion coordinates are within the "normal" region R5 ("NO" in step S22), the CPU 21 determines whether or not the personality of the robot 10 has already been acquired (step S24). In a case in which it is determined that the personality has been acquired ("YES" in step S24), the CPU 21 displays on the display 24 the state image 31 corresponding to the personality of the robot 10 (step S25). In a case in which it is determined that there is no update of the emotion coordinates ("NO" in step S21) or in a case in which it is determined that the personality has not been acquired ("NO" in step S18 or S24), the CPU 21 displays on the display the state image 31 corresponding to the standby state (step S26). In a case in which any of steps S23, S25, or S26 is completed, the CPU 21 advances the process to step S27.

In step S27, the CPU 21 repeatedly determines whether or not the animated video of the outer appearance image 311 and/or the avatar image 312 of the state image 31 has ended. In a case in which it is determined that the animated video has ended ("YES" in step S27), the CPU 21 determines whether the handling to end the management application 231 is performed (step S28). In a case in which the CPU 21 determines that no such handling has been performed ("NO" in step S28), the process is returned to step S3 in FIG. 16, and in a case in which the CPU 21 determines that such handling has been performed ("YES" in step S28), the home screen display process and the management application 231 are ended.

As described above, according to the display control method of the present embodiment, the CPU 21 executes the process of determining whether or not the robot 10 is in the state according to the priority order set for each of the plurality of states of the robot 10 with the states being a category different from each other, starting from the state with the highest priority order among the plurality of states. In a case in which the CPU 21 first determines that robot 10 is in a certain state, the CPU 21 executes a process to identify that certain state as the state of the robot 10. The CPU 21 executes the process of selecting the state image 31 corresponding to the identified state from among a plurality of state images 31 representing the above plurality of states, each of the plurality of state images 31 including the animated video, and displaying the selected state image 31 on the display 24.

Previously, the state of the target such as the robot was maintained as an internal parameter of the target, so it was not always easy to accurately determine the state of the target from the outer appearance of the target.

According to the present disclosure, it is possible to easily determine the state of the target.

According to the present disclosure, the state of the robot 10 can be shown visually and intuitively in a comprehensible manner by the state image 31 including the animated video. The robot 10 can also inform the user in a timely manner in a case in which the state is in the state of high importance to the user. In addition, depending on the state of the robot 10, the state image 31 corresponding to the relatively less important state may also be displayed, and therefore a variety of state images 31 can be displayed to attract the user's interest.

In a case in which the CPU 21 determines, based on the state information 232, that the robot 10 is in one of the following states, the power off state in which the power of the robot 10 is turned off, the communication off state in which the robot 10 and the smartphone 20 are not connected to each other, or the function suppression state in which the robot 10 is operating in the deep sleep mode or the sleep mode (function suppression mode), the CPU 21 performs the process of selecting the state image 31 corresponding to the determined state among the power off state, the communication off state, and the function suppression state from the plurality of state images 31, and displaying the selected state image 31 on the display 24. With this, it is possible to notify the user in a timely manner in a case in which the state of the robot 10 is in one of the following states that are of high importance to the user, the power off state, the communication off state, the deep sleep mode, and the sleep mode.

In a case in which it is determined that the robot 10 is not in the power off state, the communication off state, or the function suppression state, the CPU 21 performs the process to determine, based on the state information 232, whether or not the robot 10 in a state receiving a predetermined stimulus from the outside, and in a case in which it is determined that the robot 10 is in the state receiving stimulus, the CPU 21 performs the process of selecting the state image 31 corresponding to the stimulus received by the robot 10 from among the plurality of state images 31, and displaying the selected state image 31 on the display 24. This allows the state of the robot 10 and the change in the robot 10 in response to communication between the robot 10 and the user to be indicated to the user in a timely manner.

The state information 232 also includes an emotion value (element E4, emotion parameter) that represents the pseudo-emotion of the robot 10. In a case in which the CPU 21 determines that the robot 10 is not in the state receiving stimulus, the CPU 21 performs the following processes, identifying the emotion state of the robot 10 based on the emotion value included in the state information 232, selecting the state image 31 corresponding to the identified emotion state from among the plurality of state images 31, displaying the selected state image 31 on the display 24. With this, it is possible to easily grasp by the state image 31 the emotion state of the robot 10, which is difficult to confirm from the outer appearance.

The state information 232 also includes the personality value (element E5, personality parameter) that represents the pseudo-personality of the robot 10. In a case in which the CPU 21 determines that the robot 10 is not in the state receiving stimulus and the identified state image 31 is not displayed on the display 24 after the management application is started, the CPU 21 performs the process of identifying the personality state of the robot 10 based on the personality value included in the state information 232. The CPU 21 executes the process of selecting the state image 31 corresponding to the identified personality state from among the plurality of state images 31, and displaying the selected state image 31 on the display 24. With this, it is possible to easily grasp by the state image 31 the personality state of the robot 10, which is difficult to confirm from the outer appearance of the robot 10.

The animated video of the state image 31 also includes the outer appearance image 311 which represents the outer appearance of the robot 10. With this, the state of the robot 10 can be indicated visually and intuitively in a manner that is easy to understand.

The animated video of the state image 31 includes the avatar image 312, which represents the outer appearance of the avatar of the user. With this, the state of communication between the robot 10 and the user can be indicated visually and intuitively in a manner that is easy to understand.

At least some of the plurality of state images 31 include the text 313 representing the state of the robot 10. With this, the state of the robot 10 can be more clearly indicated.

Based on the state information 232, the CPU 21 executes the process of displaying on the display 24 in a predetermined arrangement, the state image 31, and the growth days image 32 and the personality image 33 as information pertaining to the robot 10 different from the state image 31 and information updated according to history of the robot 10. By displaying such state image 31, growth days image 32, and personality image 33 on the home screen 30, each reflecting the multiple factors pertaining to the state of the robot 10, the state of the robot 10 can be easily and multidimensionally grasped. In addition, since the state image 31 includes the animated video, the state of the robot 10 can be shown visually and intuitively in a manner that is easy to understand.

The area of the display region of the state image 31 is larger than the area of each display region for the growth days image 32 and the personality image 33. This makes the state image 31, including the animated video, more visible (eye-catching) to the user.

The home screen 30 also includes at least one of the following, the growth days image 32 representing the length of the cumulative operation period of the robot 10 and the personality image 33 representing the pseudo-personality of the robot 10. With this, from the image separate from the state image 31, it is possible for the user to always be able to grasp the number of days of growth and/or the personality of the robot 10, which are difficult to confirm from the outer appearance of the robot 10.

The CPU 21 also executes the process of displaying on the display 24 the detailed information screen 40 regarding the personality (certain element) of the robot 10 in a case in which the process of displaying on the display 24 the information mark 34 together with the state image 31, the growth days image 32, and the personality image 33, and the handling to select the information mark 34 are performed. With this, the user is able to grasp the detailed information pertaining to the personality of the robot 10 in a timely manner through simple handling which is selecting the information mark 34.

The CPU 21 also executes the process of displaying on the display 24 the setting screen 50 for setting the operation settings of the robot 10 in a case in which the process of displaying on the display 24 the setting button 36 together with the state image 31, the growth days image 32, and the personality image 33, and the handling to select the setting button 36 are performed. With this, the user is able to display the setting screen 50 and perform the operation settings of the robot 10 through simple handling which is selecting the setting button 36.

The CPU 21 repeatedly acquires each element of the state information 232 at a predetermined frequency and executes the process to update the home screen 30 based on the latest state information 232 acquired. This allows the home screen 30 to reflect the real-time state of the robot 10.

The robot management system 1 according to the present embodiment includes the robot 10 and the display control apparatus 200 described above. Alternatively, the robot management system 1 according to the present embodiment includes the server 60 and the display control apparatus 200 including the CPU 21 that executes the above process. This allows the state of the robot 10 to be easily grasped.

The present disclosure is not limited to the above embodiments, but can be modified in various ways. For example, according to the above embodiment, the example shows the manner in which the home screen 30 is displayed by the smartphone 20 executing various processes according to the management application 231, but it is not limited to this. For example, the server provided external to the smartphone 20 (such as the server 60 shown in FIG. 1) may control the display 24 of the smartphone 20 by sending data to the smartphone 20 to display the home screen 30 on the display 24. In this case, the computer of the server executes an information processing method that generates data for the CPU 21 as the other computer to execute the following process. The above data includes "data for the CPU (another computer) to execute a process for determining, based on the state information 232 relating to the state of the robot 10, whether or not the robot 10 is in the state according to a priority order set for each of a plurality of states of the robot 10 in different categories, starting with the state having the highest priority order among the plurality of states, a process for identifying the state of the robot 10 as the state of the robot 10 in a case in which the robot 10 is first determined to be in a certain state, a process for selecting the state image 31 corresponding to the identified state from the plurality of state images 31 each of which includes an animated video, and a process for displaying on the display 24 the selected state image". Such data may include data specifying the content and structure of the home screen 30, such as the image data or HTML (Hypertext Markup Language) data, for example. The data may also include control information for controlling the operation of the display 24. The data may also be a program for displaying the home screen 30 on the display 24. At least part of the processing executed by the CPU 21 according to the above embodiment may be executed by the computer of the server. In this case, the computer of the server may correspond to "one or more processors". The "one or more processors" may be constituted by the CPU 21 of the display control apparatus 200 and the computer of the server.

The elements representing the state of the robot 10 are not limited to the elements E1 to E6 illustrated in FIG. 6, but may be any element depending on the use of the robot 10 and other factors. For example, the elements such as fatigue, sleepiness, and physical condition may be set as elements that are updated according to the history of the robot 10, and the state images 31 and other images representing these elements may be displayed on the home screen 30.

The priority order of the states of the robot 10 is not limited to that shown in FIG. 8, but can be changed as needed depending on the use of the robot 10 and other factors. That is, the CPU 21 may determine whether or not the robot 10 is in one of the states in order from the state with the high priority order according to an arbitrarily determined priority order of the plurality of states, and in a case in which the robot 10 is determined to be in a certain state, the state image 31 corresponding to that certain state may be displayed. The priority order of the plurality of states may be changeable in response to handling by the user. The CPU 21 may decide the state image 31 to be displayed on the display 24 without regard to the priority order. For example, the CPU 21 may display the state image 31 corresponding to the last changed state among the states shown in FIG. 8.

The animated video of the avatar image 312 in the state image 31 may be omitted. Furthermore, the text 313 in the state image 31 may also be omitted, and the state image 31 may consist only of the animated video of the outer appearance image 311.

Although the example shows the manner in which the state image 31 is displayed on the display 24 of the smartphone 20, it is not limited to this. For example, in a case in which the robot 10 includes the display, the home screen 30 (or a portion of the home screen 30 that includes the state image 31) may be displayed on such display. In this case, the control for displaying the home screen 30 may be executed by the CPU 11 of the robot 10 or or may be executed remotely by a processor of an external device such as the CPU 21 of the smartphone 20.

The configuration of the robot 10 is not limited to that illustrated in FIG. 1 to FIG. 3. For example, the robot 10 may be the robot that imitates a real creature such as a person, animal, bird, fish, or the like, a robot that imitates a non-existent creature such as a dinosaur, or a robot that imitates a fictional creature.

According to the above embodiment, the example of the robot 10 as the "target" is not limited to this. The "target" can be anything that is to be a target of management by the management application 231. For example, the "target" may be any object whose parameters representing its state change. The "target" may be an avatar that operates on behalf of the user in a virtual space such as the Metaverse.

The above description also discloses an example of using flash memory in the storage 13 and the storage 23 as a computer-readable medium for the program of the present disclosure, but is not limited to this example. As other computer-readable media, information recording media such as HDD (Hard Disk Drive), SSD (Solid State Drive), CD-ROM, etc. can be applied. A carrier wave is also applicable to the present disclosure as a medium for providing data for the program according to the present disclosure via communication lines. In addition, the detailed configuration and the detailed operation of each component of the robot 10 and smartphone 20 according to the above embodiments can be suitably modified without departing from the scope of the present disclosure. The embodiments of the present disclosure are described above. However, the scope of the present disclosure is not limited to the embodiments described above, and includes the scope of the invention described in the claims and its equivalents.

1. A display control method performed by one or more processors, the method comprising:
determining, based on state information pertaining to a state of a target, whether the target is in the state according to a priority order set for each of a plurality of states of the target with the states being a category different from each other;
identifying a certain state as the state of the target in a case in which the target is determined to be in the certain state;
selecting a state image corresponding to the identified state from a plurality of state images, wherein each of the state images represents the plurality of states and each of the state images includes an animated video; and
displaying the selected state image on a display.

2. The display control method according to claim 1, wherein the one or more processors performs,
selecting, from the plurality of state images, the state image corresponding to the determined state among a power off state, a communication off state, or a function suppression state, in a case in which, based on the state information, it is determined that it is the power off state, in which power of the target is turned off, the communication off state, in which there is no connection for communication between the target and the predetermined terminal device, or the function suppression state, in which the target is operating in a predetermined function suppression mode, and
displaying the selected state image on the display.

3. The display control method according to claim 2, wherein the one or more processors performs,
determining whether the target is in the state receiving a predetermined stimulus from outside based on the state information in a case in which it is determined that it is not the power off state, the communication off state, or the function suppression state,
selecting the state image corresponding to the stimulus received by the target from the plurality of state images, in a case in which it is determined that the target is in the state receiving the stimulus, and
displaying the selected state image on the display.

4. The display control method according to claim 3, wherein,
the state information includes an emotion parameter representing a pseudo-emotion of the target, and
the one or more processors performs
identifying the state of the emotion of the target based on the emotion parameter included in the state information, in a case in which it is determined that the target is not in the state receiving the stimulus,
selecting the state image corresponding to the identified state of the emotion from the plurality of state images, and
displaying the selected state image on the display.

5. The display control method according to claim 4, wherein,
the state information includes a personality parameter representing a pseudo-personality of the target, and
the one or more processors performs,
identifying the state of the personality of the target based on the personality parameter included in the state information, in a case in which it is determined that the target is not in the state receiving the stimulus, and a predetermined state image is not displayed on the display after startup of a program for displaying the state image on the display,
selecting the state image corresponding to the identified state of the personality from the plurality of state images, and
displaying the selected state image on the display.

6. The display control method according to claim 1, wherein the one or more processors performs,
selecting the state image corresponding to the stimulus received by the target from among the plurality of state images, in a case in which, based on the state information, it is determined that the target is in the state receiving a predetermined stimulus from outside, and
displaying the selected state image on the display.

7. The display control method according to claim 1, wherein,
the state information includes an emotion parameter representing a pseudo-emotion of the target, and
the one or more processors performs,
identifying the state of the emotion of the target based on the emotion parameter included in the state information, and
selecting the state image corresponding to the identified state of the emotion from the plurality of state images, and displaying the selected state image on the display.

8. The display control method according to claim 1, wherein,
the state information includes a personality parameter representing a pseudo-personality of the target, and
the one or more processors performs,
identifying the state of a personality of the target based on the personality parameter included in the state information, and
selecting the state image corresponding to the identified state of the personality from the plurality of state images and displaying the selected state image on the display.

9. The display control method according to claim 1, wherein the animated video includes an outer appearance image representing an outer appearance of the target.

10. The display control method according to claim 9, wherein the animated video includes an avatar image representing an outer appearance of an avatar of the user.

11. The display control method according to claim 1, wherein at least some of the plurality of state images include text representing the state of the target.

12. The display control method according to claim 1, wherein the one or more processors performs displaying on the display, in a predetermined arrangement based on the state information, the state image and information that is different from the state image, that pertains to the target and that is updated according to history of the target.

13. The display control method according to claim 12, wherein an area of a display region of the state image is larger than the area of the display region of the information.

14. The display control method according to claim 12, wherein the information includes at least one of the following, information showing a length of a cumulative operation period of the target, and information showing a pseudo-personality of the target.

15. The display control method according to claim 12, wherein the one or more processors performs,
displaying on the display a first sign image together with the state image and the information, and
displaying on the display detailed information pertaining to the certain element of the state of the target in a case in which handling to select the first sign image is performed.

16. The display control method according to claim 12, wherein the one or more processors performs,
displaying on the display a second sign image together with the state image and the information, and
displaying on the display a setting screen for setting the operation of the target in a case in which handling to select the second sign image is performed.

17. The display control method according to claim 12, wherein the one or more processors performs repeatedly acquiring the state information at a predetermined frequency and updating a screen including the state image and the information based on the acquired latest state information.

18. A system comprising:
a target;
a display control apparatus; and
one or more processors of at least one of the target and the display control apparatus perform,
determining, based on state information pertaining to a state of the target, whether the target is in the state according to a priority order set for each of a plurality of states of the target with the states being a category different from each other,
identifying a certain state as the state of the target in a case in which the target is first determined to be in the certain state,
selecting a state image corresponding to the identified state from a plurality of state images, wherein each of the state images represents the plurality of states and each of the state images includes an animated video, and
displaying the selected state image on a display.

19. A system comprising:
a server;
a display control apparatus; and
one or more processors of at least one of the server and the display control apparatus perform,
determining, based on state information pertaining to a state of a target, whether the target is in the state according to a priority order set for each of a plurality of states of the target with the states being a category different from each other,
identifying a certain state as the state of the target in a case in which the target is first determined to be in the certain state,
selecting a state image corresponding to the identified state from a plurality of state images, wherein each of the state images represents the plurality of states and each of the state images includes an animated video, and
displaying the selected state image on a display.
